(19) United States
(12) Patent Application Publication
(10) Pub. No.: US 2020/0154718 A1
(43) Pub. Date: May 21, 2020

(54) COOKING COMPOSITIONS COMPRISING A CHEMICAL LEAVENING AGENT SUBSTITUTE

(71) Applicant: AAK AB, Malmö (SE)

(72) Inventor: Jeroen DEMEURISSE, Malmo (SE)

(21) Appl. No.: 16/615,469

(22) PCT Filed: May 29, 2018
(86) PCT No.: PCT/SE2018/050540

§ 371 Date: Nov. 21, 2019

(30) Foreign Application Priority Data
May 30, 2017 (SE) 1730145-8

(51) Int. Cl. A21D 2/18; A21D 13/80; A21D 2/26; A21D 8/02

(52) U.S. Cl. CPC A21D 2/186; A21D 13/80; A21D 8/025; A21D 2/185; A21D 2/26; A21D 2/181

(57) ABSTRACT

The present invention relates to a cooking composition comprising a leavening agent, wherein the leavening agent is a chemical leavening agent substitute and consists essentially of edible porous particles which encapsulate and retain a gas.

### TECHNICAL FIELD

The present invention relates to a cooking composition comprising a leavening agent, and more particularly to those of the type comprising a chemical leavening agent.

### BACKGROUND OF THE INVENTION

Over the last decade within the food industry there has been a growing trend of consumers becoming increasingly conscious of the ingredients contained within food products. As part of this process a significant percentage of consumers have come to favour food products having fewer chemical ingredients. Such food products are commonly referred to as ‘clean-label’ products.

In particular, consumers are increasingly avoiding food products comprising, for example, artificial preservatives, artificial flavours, genetically modified ingredients and E-numbers. E-numbers signify the presence of a specific artificial additive, which in principle are permitted for use within the European Union.

In response to this, food manufactures are seeking to provide suitable alternatives, preferably based on natural ingredients and their derivatives.

Despite the fact that consumers are turning to clean-label products, quality, taste and/or shelf-life of a product are still highly important and consumers are generally unwilling to sacrifice these.

Accordingly, not only is it important to find suitable alternatives, but such alternatives must be able to produce similar properties to those containing, for example, artificial preservatives, artificial flavours, genetically modified ingredients and E-numbers.

The present invention is concerned with the provision of clean-label baked products. However, one particular issue associated with the formation of such clean-label baked products is maintaining the light, airy structure which consumers have come to expect from such products.

In general, the porous structure of baked products is produced by heterogeneous nuclei (small air bubbles) within a dough or batter before baking, and which are formed during the mixing process. Small gas bubbles only survive if they have a minimum radius ‘r’ (Laplace: ΔP=γ/2r, where ΔP is the difference between inside and outside of a curvature and γ the surface tension of the liquid), and mass transport of gas from small to big bubbles is driven by this Laplace pressure. This is one of the mechanisms responsible for the number of air bubbles present within a dough or batter, which after baking can be reduced to less than 5% of the air bubbles present before baking. Such a significant reduction in air bubbles inevitably affects the texture of the resulting food product.

Traditionally, in order to overcome this effect, a leavening agent is added to the cooking composition.

Once activated, traditional leavening agents produce a gas, such as carbon dioxide. This gas, together with water vapour contained within the dough or batter, expands upon heating and thus creates the light, airy structure of baked goods.

The gas first dissolves into the dough or batter and is then released into the air bubbles which are already present in the dough or batter. By increasing the amount of gas present in each of the air bubbles, the size of the air bubble is increased and consequently the Laplace pressure is decreased. Thus, the leavening agent helps to increase the number of air bubbles remaining after baking.

The leavening agents which can be incorporated into a dough or batter fall into two categories, biological leavening agents and chemical leavening agent. Biological leavening agents, such as yeast, are living organisms which consume a portion of the sugars present in the mixture and produce carbon dioxide. Chemical leavening agents create a gas, such as carbon dioxide, as a result of a chemical reaction.

Suitable chemical leavening agents can react with an acid in the presence of moisture to form a gas, for example sodium bicarbonate (baking soda) will react with an acid in the presence of moisture to form carbon dioxide, a sodium salt and water, as shown in Equation 1.

NaHCO₃+HX→NaX+H₂O+CO₂↑ (Equation 1)

Although sodium bicarbonate is one of the most commonly used leavening agents in baking compositions, it is classified by way of an E-number (specifically E 500), along with other commonly used chemical leavening agents, such as ammonium bicarbonate (E 503) and potassium carbonate (E 501), and therefore its use in food compositions is undesirable.

Furthermore, when sodium bicarbonate is heated to a temperature greater than 60° C. in the absence of an acidulant (also referred to as leavening acid), only some carbon dioxide is liberated and sodium carbonate remains in the food product—problems with respect to excess sodium carbonate are discussed below.

Due to this undesirable effect, manufactures ensure that sufficient amounts of acidulent are added to the food composition. However, most common acidulants are also classed by way of E-numbers (see Table 1 below).

TABLE 1

| Acidulent | E number |
|---|---|
| Calcium Phosphates | |
| Monocalciumphosphate | E 341 |
| Dicalciumphosphate-Dihydrate | E 341 |
| Monocalcium orthophosphate monohydrate | E 341 |
| Calcium Acid PyroPhosphate | E 450 |
| Sodium Phosphates | |
| Sodium Acid PyroPhosphate | E 450 |
| Sodium Acid Aluminium Phosphate | E 541 |
| Sodium Acid Aluminium Phosphate Hydrate | E 541 |
| Organic Acids | |
| Gluconodeltalactone | E 575 |
| Others | |
| Potassium Bitartrate | E 336 |

The presence of unreacted sodium bicarbonate results in a yellowish crumb, undesired surface colouring and an unpleasant taste (‘soda bite’) in the resulting food product.

Further, many of the chemical leavening agents traditionally used, such as sodium bicarbonate, along with many commonly used acidulents, comprise sodium. It is well known that high dietary intake of sodium has been linked to numerous health risks and diseases, such as high blood pressure, heart attacks and strokes, and so for this additional reason, it is desirable to look at alternative leavening agents which can mimic the results of traditional chemical leavening agents.

In addition to concerns relating to chemicals present in food, consumers are also aware of the health risks associated with high sugar consumption. For example, regularly consuming high quantities of sugar can lead to excessive weight gain which, in turn, can lead to type two diabetes and/or heart disease. Thus, food products in which traditional sugar content can be reduced with healthier alternatives are also becoming increasingly appealing to consumers. National Governments are also taking an increasing interest in this aspect with food manufacturers being encouraged to produce healthier alternatives, with taxes specifically focussed on sugary foods being mooted.

In order to try and address one or more of the above mentioned issues, an alternative leavening agent is sought which, ideally in use, is not classifiable as an E-number but which results in food products having properties similar to those obtained using traditional chemical leavening agents.

It will be noted that the use of porous particles containing entrapped pressurized gas is known within the food industry, however, to date, its use is very different to that of the present invention. WO2006/023564 teaches a foaming composition for drinks, such as cappuccinos, and foods, such as instant soups, comprising a powdered protein-free soluble composition comprising carbohydrate particles having a plurality of internal voids containing entrapped pressurized gas. The composition is formed by subjecting the particles to an external gas pressure prior to or while heating the particles to a temperature of at least the glass transition temperature (T_{g}) followed by cooling the particles to a temperature below T_{g} prior to or while releasing the external gas pressure. WO '564 teaches that any food-grade gas can be used, such as air, carbon dioxide, nitrous oxide, or a mixture thereof.

EP1627568B1 teaches a foaming soluble coffee powder containing internal voids filled with pressurized gas. Suitable gases include air, carbon dioxide, nitrogen gas, and nitrous oxide. The foaming soluble coffee powder can be formed by pressurizing the coffee product using a suitable gas and heating the pressurized coffee product, preferably to a temperature above the glass transition temperature (T_{g}). The coffee product is then cooled to room temperature and depressurised.

Similar to WO2006/023564, EP2179657 describes gas-effusing compositions for drinks, such as cappuccinos, and foods, such as instant soups, comprising particles having a plurality of internal voids within the particles and an edible gas contained within the internal voids at a second high pressure. The particles further comprise restrictive passageways in order to contain the edible gas within the particle, wherein the restrictive passageways have a diameter of less than about 1 μm. EP '657 teaches that the disclosed particles can be formed from a carbohydrate, protein and/or mixtures thereof, wherein the particle quickly dissolve when contacted with an aqueous medium thereby releasing the edible gas into the aqueous medium.

EP1206193B1 teaches a powdered soluble foamer ingredient for producing enhanced foam in foodstuffs and beverages, wherein the foamer ingredient comprises a matrix containing carbohydrate and protein and an entrapped gas under pressure. The matrix may further comprise a fat in order to help entrap the gas. Preferably, the soluble foamer ingredient comprises a closed pore structure.

WO2004/019699 describes a foaming ingredient which essentially consists of one or more proteins and optionally one or more plasticizers forming the wall of vacuoles that comprise entrapped gas. WO '699 teaches that by using a foaming ingredient that is at least 85% by weight protein, smaller vacuoles are formed in greater numbers compared with a foaming ingredient comprising carbohydrate as a further component. The smaller vacuoles are considered to be more stable and also lead to the production of increased amounts of foam.

WO2015/053623 describes powder compositions to be used in instant food, wherein the powder composition comprises:
a. a gas release agent in particulate form;
b. a hydrocolloid in particulate form; and
c. an instant food component in particulate form.

WO '623 teaches that upon contact with an aqueous fluid, gas bubbles are formed from the gas releasing agent, and the gas bubbles formed are entrapped in the continuous phase as opposed to forming a foam/froth on top of the aqueous liquid. The gas release agent may be in a particulate form and contain a gas phase entrapped in a matrix, wherein the gas releasing agent may be formed from carbohydrates, proteins, fats, and emulsifiers. The gas contained in the gas release agent may be selected from air, oxygen, nitrogen, carbon dioxide, nitrous oxide, or mixtures thereof.

However, it will be appreciated that despite such disclosures, at no time has it ever been taught or even remotely suggested to use such powder compositions in food products with a lower water content, such as dough or batter for bakery applications.

### SUMMARY OF INVENTION

In one aspect, the present invention relates to a cooking composition comprising a leavening agent, wherein the leavening agent is a chemical leavening agent substitute and consists essentially of edible porous particles which encapsulate and retain a gas.

In a further aspect, the present invention relates to a dough or a batter formed from the cooking composition according to any embodiment herein.

In still a further aspect, the present invention relates to a process of forming a cooking composition, a dough or a batter, said process comprising the steps of a) mixing wet components; b) mixing dry components, including a leavening agent consisting essentially of edible porous particles which encapsulate and retain a gas; and c) blending a) and b) until a dough or batter is formed.

In still a further embodiment, the present invention relates to a process of forming a cooking composition, dough or batter for use in producing cooked products, comprising the steps of: a) mixing wet components, including a leavening agent consisting essentially of edible porous particles which encapsulate and retain a gas; b) mixing dry components; and c) blending a) and b) until a dough or batter is formed.

Still further aspects relate to a cooked food product formed from a cooking composition, dough or batter according to any one of the embodiments of said dough or batter herein.

Even further aspects relate to a process of forming a cooked food product, comprising the steps of: a) forming a dough or batter, wherein the dough or batter comprises the cooking composition according to any embodiments herein, and b) cooking the dough or batter.

Even still further aspects relate to a cooked food product produced by the process of any one of the embodiments herein.

Yet even still further aspects relate to use of edible porous particles which encapsulate and retain a gas as a leavening agent in a cooking composition and/or as a chemical leavening agent substitute in a cooking composition.

### DISCLOSURE OF THE INVENTION

In accordance with the present invention, there is provided a cooking composition comprising a leavening agent, wherein the leavening agent is a chemical leavening agent substitute and consists essentially of edible porous particles which encapsulate and retain a gas.

The term “cooking composition” is intended to include any composition which can be used to produce a food product, such as biscuits, muffins, donuts, bread, pizza base, cookies, hardtack, pretzels, cut bread, wafers, sable, Langue du chat, macaroons, butter cakes (such as pound cake, fruit cake, Madeleine, Baumkuchen, castella), sponge cakes (such as short cake, roll cake, torte, decorated cake, chiffon cake), cream puffed confectionery, fermentation pastry, western style fresh confectionery such as pie and waffle, sweet buns, French bread, stollen, panettone, brioche, Danish pastry and croissants or crackers. Preferably the food product is a cookie, a biscuit, a pizza base or a cracker. The cooking compositions of the present invention can be formulated into doughs, mixtures and/or batters depending on their intended use. The edible porous particles of the present invention which encapsulate and retain a gas allow for the production of food products having similar properties to those produced by known chemical leavening agents in the art.

Without wishing to be bound by any particular theory, whilst biological and chemical leavening agents produce gas, typically CO₂, by a reaction mechanism, the edible porous particles of the present invention release the encapsulated gas when the encapsulation is at least partially removed or is ruptured.

For example, when the encapsulation material is physically ruptured or fractured, or alternatively, is dissolved in a liquid medium.

In a further example, when the gas is retained under pressure, the encapsulated gas may be released when the pressure difference is decreased due to dissolving, melting or dissolution of the particle.

In some embodiments, the edible porous particle itself encapsulates the edible gas. For example, the edible porous particles of the present invention are in the form of a hollow shell around the encapsulated gas. In an alternative embodiment, the edible porous particle may be a closed-cell porous particle comprising the encapsulated gas within the closed-pores.

In other embodiments, the edible porous particles of the present invention are selected from an open-cell porous particle. In order to prevent or impede the release of gas therefrom, the open-cell porous particles may further comprise a restricted passageway, such that at least a portion of the pores may have a diameter that is less than about 1 μm, for example less than about 0.1 μm, such as less than about 0.01 μm, and, even as low as less than about 0.001 μm.

In some embodiments, the edible porous particles may further comprise a coating in order to prevent or impede the release of gas from the edible porous particle.

In embodiments wherein the edible porous particles are selected from open-cell porous particles or those comprising restricted passageways, such a coating may be used to ‘plug’ the open-cell pores and/or to substantially coat and encapsulate the edible particle. In some embodiments, the coating layer may entirely coat and encapsulate the edible particle.

In embodiments wherein the edible porous particles are selected from closed-cell porous particles or particles formed as a hollow shell, a coating layer may still be provided. It will be appreciated that such a coating may be used to aid in the control of the release of gas from the edible porous particles.

The edible porous particles of the present invention may be formed from E-number free carbohydrates, proteins, fats and other E-number free ingredients or combinations thereof. Preferably, the edible porous particles are formed from E-number free carbohydrates, proteins or combinations thereof. In preferred embodiments, the edible porous particles are substantially free of protein. Preferably the edible porous particles comprise less than 1 wt % of protein, such as less than 0.5 wt % of protein.

In an alternative embodiment, at least 85 wt % of the edible porous particles of the present invention is formed from one or more protein(s), preferably at least 90 wt %, more preferably 95 wt %. Most preferably, the edible porous particle of the present invention is essentially formed from one or more protein(s).

In a further preferred embodiment, at least 85 wt % of the edible porous particles of the present invention is formed from one or more carbohydrate(s), preferably at least 90 wt %, more preferably 95 wt %. Most preferably, the edible porous particle of the present invention is essentially formed from one or more carbohydrate(s).

In a further alternative embodiment, the edible porous particles are substantially free of carbohydrate(s). Preferably, the edible porous particles comprise less than 1 wt % of carbohydrate(s), such as less than 0.5 wt % of carbohydrate(s).

Carbohydrates which are suitable for use with the present invention include, but are not limited to polyhydric alcohols, sugars, sugar alcohols, oligosaccharides, polysaccharides, starch, starch hydrolysis products, gums, soluble fibers, modified starches, modified celluloses, and mixtures thereof.

Carbohydrates which are particularly suitable for use with the present invention, particularly as they are E-number free, may be selected from sugars, oligosaccharides, polysaccharides, starch, starch hydrolysis products, soluble fibers, and mixtures thereof.

Sugars which are suitable for use with the present invention include glucose, fructose, sucrose, lactose, mannose, trehalose, and maltose.

The types of starch which are particularly suitable for use with the present invention are corn, pea, potato, sweet potato, sorghum, banana, barley, wheat, rice, sago, amaranth, tapioca, arrowroot, canna or a combination thereof. Starch hydrolysis products which are also suitable for use with the present invention include maltodextrins, such as tapioca maltodextrin, glucose syrups, corn syrups, high-maltose syrups, and high-fructose syrups.

Proteins which are suitable for use with the present invention include, but are not limited to, milk proteins, soy proteins, egg proteins, gelatin, collagen and wheat proteins.

The edible porous particles of the present invention may have a mean particle size of 1 to 5000 μm, preferably 5 to 2000 μm, and more preferably 10 to 1000 μm. In some embodiments, the edible porous particles may have a mean particle size of less than 250 μm, such as less than 100 μm, preferably less than 50 μm, and more preferably less than 20 μm.

In a particularly preferred embodiment, the edible porous particles have a mean particle size between 20 and 200 μm, such as between 50 and 175 μm, preferably between 75 and 150 μm.

The term “particle size” as used in accordance with the present invention is considered to relate to the diameter of the edible porous particle encapsulating and retaining a gas as used in the cooking composition. Thus, in some embodiments of the present invention the particle size will be the diameter of the particle itself. However, for embodiments wherein the gas retaining particle further comprises a coating layer, the particle size is considered to be the diameter of the coated particle, i.e. including the coating layer.

The particle size of the edible porous particles can be determined by measuring their Brownian motion. This can be achieved using Dynamic Light Scattering (DLS), wherein the fluctuations of scattered light caused by a solution or suspension of particles are measured. Any suitable DLS instrument can be used to measure the Brownian motion of particles. It is considered to be within the abilities of a person of skill in the art to select a suitable solvent in which the selected edible porous particle of the present invention would form a solution or suspension. Alternatively, the particle size of the edible porous particles can be determined using microscopic techniques, for example Scanning Electron Microscope (SEM) techniques, wherein the surface of the sample to be analyzed is bombarded with a focused beam of electrons. The signals subsequently produced by the electron-sample interactions are detected for each position by an electron detector. The intensity of the emitted electron signal is displayed as brightness on a display monitor thereby imaging the sample. From this image the particle size of the porous particles can be determined. A further option is laser diffraction, which measures particle size distributions by measuring the angular variation in intensity of light scattered as a laser beam passes through a dispersed particulate sample. Large particles scatter light at small angles relative to the laser beam and small particles scatter light at large angles, as illustrated below. The angular scattering intensity data is then analyzed to calculate the size of the particles responsible for creating the scattering pattern, using the Mie theory of light scattering. The particle size is reported as a volume equivalent sphere diameter.

The edible porous particles may have a bulk density of less than 1 g/cm³, preferably less than 0.5 g/cm³, and more preferably less than 0.2 g/cm³. For example, the edible porous particles may have a bulk density of 0.1 to 1 g/cm³, preferably 0.1 to 0.7 g/cm³, and more preferably 0.2 to 0.6 g/cm³.

Bulk density (g/cm³) is determined by measuring the volume (cm³) that a given weight (g) of material occupies when poured through a funnel into a graduated cylinder.

As discussed above, the edible porous particles may be formed as a hollow shell or comprise open and/or closed pores. Accordingly, the edible particles of the present invention typically have an internal void volume in the range of 2 to 80%, typically 10 to 70% and more typically 20 to 60%.

It will be appreciated that the gas contained within the porous particles of the present invention must be suitable for human consumption. The edible gas may be selected from nitrogen, carbon dioxide, nitrous oxide, air, argon, oxygen, helium, hydrogen or mixtures thereof. Preferably, the edible gas is carbon dioxide or nitrogen.

In a preferred embodiment, the edible gas encapsulated and retained within the edible porous particles is under pressure. It would be clear to the person of skill in the art that by encapsulating the gas under pressure, increased amounts of gas can be stored in the edible porous particles. Thus, the inclusion of lower amounts of edible porous particles are required in cooking compositions to achieve the same leavening effect.

It will be understood that the term “under pressure” or “pressurized gas” is intended to mean a gas retained at a pressure greater than ambient pressure, and may also be known as superatmospheric pressure gas.

The particles of the present invention are generally capable of retaining useful volumes of gas, whether stored at atmospheric pressure or in a pressurized form, for predetermined time periods. Such periods may range from minutes to years, depending, for example, on the physical properties of the material, the pressure and composition of the gas held therein, storage temperature, and packaging methods.

The edible porous particles may contain pressurized gas in the range of 137.90 to 20,684.27 kPa (20 to 3000 psi), typically 689.48 to 13,789.51 kPa (100 to 2000 psi) and more typically 2,068.43 to 10,342.14 kPa (300 to 1500 psi).

The edible porous particles containing pressurized gas may release, in use, at least about 5 ml gas/g of particles, more preferably at least about 10 ml gas/g of particles, most preferably at least about 20 ml gas/g of particles. The release might even be higher than at least 40 ml gas/g of particles.

In a preferred embodiment, the cooking composition of the present invention comprises an edible porous particle which encapsulates and retains a gas, wherein the porous particle is formed from a material which will dissolve in an aqueous based medium. Preferably, the gas is retained under pressure.

In an alternative embodiment, the cooking composition of the present invention comprises an edible porous particle which encapsulates and retains a gas, wherein the porous particle is formed from a material which softens and/or decomposes upon heating. Preferably, the gas is retained under pressure.

Such particles may be particularly beneficial with respect to mouthfeel in the final baked product.

Edible porous particles which encapsulate and retain a gas may be produced using known methods. Such known methods, and the particles produced therefrom, are disclosed in WO2006/023564, EP1206193 and EP2179657.

By way of example, conventional gas-injected spray drying of aqueous solutions may be used to manufacture porous particles. Spray drying of aqueous solutions without gas injection typically produces particulate compositions having relatively small internal void volumes. Gas-injected spray-drying can be conducted by dispersing gas or pressurized gas into an aqueous solution (preferably to provide a ratio of about 1 to 6, more preferably about 2 to 4, litres of gas per kilogram of dry solids dissolved in the aqueous solution and/or removed from the spray dryer) using any effective gas dispersing method, either before being transported to the spray-dryer or during spray-drying. The spray-dried particles are then subjected to an inert gas atmosphere at high pressure and at a temperature above the glass transition temperature of the particles. The pressure may be from 137.90 kPa to about 20,684.27 kPa (20 psi to about 3000 psi). The temperature needed will depend upon the composition of the particles since this will influence the glass transition temperature. However, the temperature may be readily set for any particle type by the skilled person. Temperatures more than about 50° C. above the glass transition temperature are probably best avoided. The particles may be subjected to the pressure and temperature for as long as desired since increasing the time will generally increase the gas entrapment. The particles are then subjected to rapid quenching or curing to ensure entrapment of the gas. Rapidly releasing the pressure or suitable cooling may be well sufficient to quench the particles

As discussed above, in some embodiments, the edible porous particles of the present invention further comprise a coating layer on the surface of the porous particles in order to retain the edible gas therein or to further reinforce the encapsulation of the edible gas by the porous particles.

It will be understood that the coating layer selected must also be formed from an edible material. In addition, the coating layer must dissolve or disintegrate when desired. By way of example, the coating may dissolve when in contact with an aqueous base medium and/or on heating.

It will be understood that the use of an edible coating layer also allows for the preparation of a particle which can improve the porosity of the resulting cooked food product. More specifically, such an improvement may be associated with the melting, softening or decomposition of the edible coating layer upon baking of the food composition. Such melting, softening or decomposition results in removal of the coating layer from the porous particle and therefore an increase in porosity within the food product itself. In some instances the presence of increased porosity within the edible product occurs at a temperature at which the product begins to set due to starch gelatinisation, protein denaturation and moisture loss.

In some embodiments, the coating layer may be used to delay the release of the gas present within the edible porous particles. For example, the extent to which the release of the gas is delayed may be linked to the thickness of the coating layer. Alternatively, the extent to which the release of the encapsulated gas is delayed may be due to the composition of the coating material, i.e. the solubility of the material and/or its melting point.

In an alternative embodiment, the coating layer may be formed of two or more layers, wherein each layer may be selected from the same or different materials.

In addition, the coating layer may also be used to control the release of the edible gas from the edible porous material depending on when it is desired for the gas to be released. Furthermore, the person of skill in the art would be aware that the matrix properties of the edible porous particles will inevitably affect the release rate of the gas.

It will be understood that a number of different factors may be used to control the release of the gas. By way of example, the release of the encapsulated gas may at least in part be controlled by the coating layer, where present.

The coating layer is preferably selected from a fat, starch, or a protein, such as gelatin or collagen, or a combination thereof. More preferably, the coating layer is selected from a fat, starch, or a protein which is free of E-numbers. In some embodiments, the coating layer is selected from one or more of xanthan, alginates, carrageenans, guar, gellan, locust bean, and hydrolysed gums. In an alternative embodiment, a particularly preferred material for use as a coating layer is fat or oil. Fats and oils which are particularly preferred as coating layers include, but are not limited to, one or more of lard, tallow, lauric fats, such as coconut oil and/or palm kernel oil, stearin fractions, as well as interesterified and/or hydrogenated fats or oils. Preferably, the fat is selected from fully hydrogenated palm kernel oil, a palm mid fraction, a palm stearin and/or a palm kernel stearin.

When a fat or oil is used as a coating layer the release of the leaving agent is further delayed by delaying the disintegration of the edible porous particles. This can be beneficial in some embodiments. The release of the leaving agent is initiated upon melting of the fat coating after heating of the resulting cooking composition.

In an embodiment where the solubility of the edible porous particles is increased the coating layer of these particles becomes more important. An increased solubility of the edible porous particles may be beneficial when the amount of water present in the cooking composition is limited. The coating layer may then be used to control the release of the encapsulated leaving agent, because it is the coating layer which becomes a rate limiting step.

When producing bakery products it is important that the leaving agent is not released during the mixing phase of the dough or batter, but rather is released during the baking of the resulting cooking composition. Otherwise the intended achievement of volume and porosity in the end product is not produced.

Fat as a coating layer has the additional benefit that fat on its own provides porosity. This is known by the person skilled in the art. By using fat as a coating layer on the edible porous particles a synergistic effect can be argued to occur with regard to porosity in the resulting food product.

Preferably the amount of fat is at least 10 wt % of the total edible porous particles, preferably at least 15 wt %, more preferably at least 25 wt %. Preferably, the porous edible porous particles are fully covered with fat (FIG. 2).

The person of skill in the art would be aware that the coating layer must be selected from a material that causes substantially no co-aggregation or only a limited amount of co-aggregation between the coated edible porous particles of the present invention. Furthermore, it will be generally understood that it is preferable for the coating layer to be selected from a material having a melting point falling within the temperatures typically used for cooking food products. In a preferred embodiment, the coating layer is selected from a material having a melting point higher than 20° C., more preferably higher than 35° C. In another preferred embodiment, the coating layer will be selected from a material having a melting point of 60° C. or less, more preferably 50° C. or less. In a particularly preferred embodiment, the coating layer is selected from a fat having a melting point between 20° C. and 60° C., more preferably between 35° C. and 50° C.

In some embodiments, the cooking composition may comprise edible porous particles which encapsulate and retain a gas, in an amount of from 0.05 to 20 wt %, for example 0.1 to 10 wt %, such as from 0.5 to 8 wt %, or even from 1 to 5 wt % by weight of the cooking composition as a whole.

It is readily apparent that there is a benefit to being able to use small edible porous particles containing a gas, such as pressurized gas, to create pore structures in a baked product similar to the pore structure produced by the use of traditional chemical leavening agents.

However, in embodiments where the edible porous particle remains within any cooked food product after it has been produced, the edible porous particles must also be small enough not to significantly affect the texture or consistency of the food product, as well as mouth feel.

The cooking composition may further comprise an additive to delay starch gelatinisation. During a cooking process, such as baking, the structure of the food product becomes set due to starch gelatinisation, protein denaturation and moisture loss. As starch is heated it gelatinizes causing the viscosity of the dough or batter to increase, thereby stabilizing the structure of the baked food product. Due to this process, the volume expansion of the product stops. Typically, gelatinisation takes place at a temperature between 52° C. and 99° C. In industrial process, such as for the manufacture of cookies and biscuits, a temperature increase to within this range can be achieved within 30 seconds, and so the creation of volume within a baked product can be complete within the first few minutes. The additive slows down this process thus allowing more time for gas to be incorporated into the air bubbles and thus increase the volume created within the cooked product.

Suitable additives that can be used to delay starch gelatinisation include inulin, sugar, salt, a high molecular weight carbohydrate, an edible acid and monoglyceride, or a combination thereof. Preferably inulin is used to delay starch gelatinisation.

Although delaying starch gelatinisation can increase the pore size of the resulting baked food, significant delays relating to the onset of starch gelatinisation decreases the efficiency at which the baked goods are produced. Consequently, when such products are produced on a mass scale, these delays can reduce cost efficiency of the process. Accordingly, the amount used must be carefully controlled.

The cooking composition of the present invention may comprise from 0.1 to 10 wt % of starch gelatinisation additive, preferably from 0.5 to 8 wt %, and more preferably from 1 to 5 wt %.

The cooking composition of the present invention may further comprise a biological leavening agent. Biological leavening agents are generally used when the cooking composition is intended for the production of bread-like products, including bread, pizza and doughnuts.

Preferably, the biological leavening agent is selected from yeast and sour dough.

Where present, the biological leavening agent may be used in an amount of from 0.1 to 5 wt %, preferably from 0.5 to 3 wt %, and more preferably from 1 to 2 wt %.

Where a biological leavening agent is used in addition to the edible porous particles, the total amount of leavening agent i.e. the combination of both the biological leavening agent and the edible porous particles is generally from 0.2 to 10 wt %, preferably from 1 to 8 wt %, and more preferably from 2 to 5 wt %.

In an alternative embodiment, the chemical leavening substitute of the present invention is substantially free of a biological leavening agent.

The cooking composition may comprise one or more of flour (generally in an amount of 20 to 70 wt %), milk powder (where present generally in amount of up to 10 wt %), sugar (where present generally in amount of up to 50 wt %), sugar substitutes (where present generally in amount of up to 50 wt %), protein (where present generally in amount of up to 5 wt %), powdered emulsifiers (where present generally in amount of up to 5 wt %), starch (where present generally in amount of up to 20 wt %), salt (where present generally in amount of up to 5 wt %), spices (where present generally in amount of up to 5 wt %), flavour components (where present generally in amount of up to 5 wt %), powdered colourants (where present generally in amount of up to 5 wt %), cocoa (where present generally in amount of up to 5 wt %), thickening and gelling agents (where present generally in amount of up to 5 wt %), egg powder (where present generally in amount of up to 10 wt %), enzymes (where present generally in amount of up to 2 wt %), gluten (where present generally in amount of up to 5 wt %), preservatives (where present generally in amount of up to 2 wt %), sweeteners (where present generally in amount of up to 30 wt %), oxidising agents (where present generally in amount of up to 2 wt %), reducing agents (where present generally in amount of up to 2 wt %), anti-oxidants (where present generally in amount of up to 2 wt %) and acidity regulators (where present generally in amount of up to 2 wt %). Such components are in general added in dry form, and may be known collectively as ‘dry components’.

In the cooking compositions of the present invention, at least part of the sugar present in a traditional recipe may be replaced with a sugar substitute. Such sugar substitutes can replace up to 25 wt %, preferably up to 50 wt %, more preferably up to 75 wt %, and most preferably 100 wt % of the sugar.

The sugar substitute may be selected from acesulfame potassium, agave nectar, aspartame, neotame, stevia leaf extract, saccharin, sucralose, and inulin or a combination thereof. Preferably, the sugar substitute is inulin.

The cooking composition may comprise one or more of eggs (where present generally in an amount of up to 40 wt %), water (generally in an amount of 1 to 50 wt %), liquid emulsifier (where present generally in an amount of up to 5 wt %), liquid sugar and syrups (where present generally in an amount of up to 25 wt %), milk (where present generally in amount of up to 40 wt %), liquid flavours (where present generally in amount of up to 5 wt %), liquid colourants (where present generally in amount of up to 5 wt %), alcohols (where present generally in amount of up to 5 wt %), humectants (where present generally in amount of up to 5 wt %), honey (where present generally in amount of up to 10 wt %), liquid preservatives (where present generally in amount of up to 2 wt %), liquid sweeteners (where present generally in amount of up to 30 wt %), liquid oxidising agents (where present generally in amount of up to 2 wt %), liquid reducing agents (where present generally in amount of up to 2 wt %), liquid anti-oxidants (where present generally in amount of up to 2 wt %), liquid acidity regulators (where present generally in amount of up to 2 wt %) and liquid enzymes (where present generally in amount of up to 2 wt %). Such components are in general added in wet form, and may be known collectively as ‘wet components’.

The cooking composition may also comprise a fat or an oil, or emulsions thereof with water. Examples of such emulsions include margarine and butter. For the purposes of this invention, the fat component may be considered a wet component.

Such fats or oils may be animal or vegetable derived, or blends thereof.

The composition of the fat phase is not considered to be critical. Typically fats and oils that are employed include highly unsaturated liquid oils (e.g. sunflower oil, soybean oil and/or rapeseed oil), lauric fats (e.g. coconut oil and/or palmkernel oil), palm oil and milk fat, all with fractions thereof, such as olein and/or stearin fractions, as well as interesterified and/or hydrogenated fats or oils thereof that may suitably be used. Lard and tallow may also be used. Thus, blends of oils, fats and fractions thereof may also be employed, in hydrogenated and/or interesterified forms.

It will be appreciated that the types of wet and dry components to be used are dependent on the type of cooking composition desired. A person of skill in the art in this field is able to select the necessary components, and their relative amounts, according to the desired final product, for example, biscuit, cake, muffin, cookie, donut, pastry, bread, pizza base or cracker.

In general, in the cooking compositions of the present invention, flour may be present in an amount of 20 to 70 wt %.

In general, in the cooking compositions of the present invention, water may be present in an amount of 1 to 50 wt %.

Where present in the cooking compositions of the present invention, sugar may be present in an amount of up to 50 wt %. However, as noted above, at least a portion of this sugar content may be replaced by a sugar substitute.

Where present in the cooking compositions of the present invention, salt may be present in an amount of up to 5 wt %.

In general, in the cooking compositions of the present invention, fat may be present in an amount of up to 40 wt %.

The cooking compositions of the present invention may be mixed so as to produce doughs or batters.

By a dough, reference may be made to a soft or stiff dough, which types of dough are well known in this field. Such dough compositions generally comprise flour, water, sugar, salt, fat and the edible porous particles.

A preferred dough composition, for forming a baked food product, may comprise:
20 to 70 wt % (preferably 40 to 65 wt %) Flour
1 to 50 wt % (preferably 5 to 20 wt %) Water
0 to 50 wt % (preferably 5 to 30 wt %) Sugar
0 to 5 wt % (preferably up to 2 wt %) Salt
0.5 to 5 wt % Leavening agent in accordance with the present invention
0 to 40 wt % (preferably 5 to 30 wt %) Fat

By a batter, reference may be made to a drop or pour batter, which types of batter are well known in this field.

It will be understood that the components forming the cooking composition can be combined using known techniques in the art. Suitable mixing devices are well known in the art and include those, for example, sold by Hobart, Fimar, GAM, Sirman and Sammic.

The length of time required to mix the cooking composition is dependent on, amongst other things, the number of dry and wet components to be combined, the weight and/or volume of each of the components as well as the viscosity of the composition formed. In general, suitable mixing times can include from 10 seconds to 1 hour, such as from 1 to 45 minutes, and including from 5 to 30 minutes. For example, the wet and dry components are blended for at least 30 seconds, preferably for at least 1 minute, more preferably for at least five minutes, such as for at least 10 minutes.

In a preferred embodiment, the components of the cooking composition are mixed for a sufficient time in order to produce a substantially homogeneous distribution of the edible porous particles throughout the dough or batter formed.

In addition, in principle, the components of the cooking composition can be combined in any order.

The edible porous particles may be combined with other components of the cooking composition so as to form an admixture of dry particles, a blend, a suspension or a solution.

By way of example, the cooking composition of the present invention (and therefore also a dough and/or batter) may be produced by a method comprising the steps of:
a. mixing the wet components;
b. mixing the dry components, along with a leavening agent consisting essentially of edible porous particles which encapsulate and retain a gas; and
c. blending a. and b. until a dough or batter is formed.

In a preferred embodiment, the dry components and edible porous particles are mixed such that the edible porous particles are distributed substantially homogeneously throughout the dry components before they are blended with wet components.

By way of further example, the cooking composition of the present invention (and therefore also a dough and/or batter) may be produced by a method comprising the steps of:
a. mixing wet components, along with a leavening agent consisting essentially of edible porous particles which encapsulate and retain a gas;
b. mixing dry components; and
c. blending a. and b. until a dough or batter is formed.

In a preferred embodiment, the wet components and edible porous particles are mixed such that the edible porous particles are distributed substantially homogeneously throughout the wet components before they are blended with dry components.

In preparing the wet components of step a., the method preferably comprises the step of mixing the edible porous particles with a fat or an oil, or emulsions thereof with water. By way of example, the edible porous particles may be blended with a fat or an oil, or emulsions thereof with water, such that the edible porous particles are homogeneously distributed throughout the fat.

It will be appreciated that the step of mixing helps to create air bubbles within the cooking composition. The method may therefore further include additional physical leavening steps. By way of example, such a step may include whisking or beating one or more of the wet components during the process for producing the cooking composition.

Preferably, where a dough is formed from the cooking composition, the method may further comprise the step of kneading the dough once it has been formed.

The present invention is also directed to precursor compositions which can be used in the production of cooking compositions, doughs and/or batters in accordance with the present invention.

Such precursor compositions may comprise a limited number of components which are pre-blended and suitable for use in producing a cooking composition, dough and/or batter in accordance with the present invention.

A preferred precursor composition comprises a mixture of at least edible porous particles and inulin. It will be understood that the relative amounts of edible porous particles and inulin in the mixture will be selected such that they are able to form a cooking composition, dough and/or batter such as described above.

In another preferred precursor composition, the mixture of edible porous particle and inulin further comprises a fat. Again, the relative amounts of edible porous particles, inulin and fat in the precursor composition will be selected such that they are able to form a cooking composition, dough and/or batter such as described above. For the precursor compositions, the weight ratio by parts of porous particles to inulin, relative to the precursor compositions as a whole, may be in the range of 5:1 to 1:5, such as 3:1 to 1:3, and including 2:1 to 1:2.

The cooking composition, dough and/or batter of the present invention are/is suitable for producing cooked food products. Such products can be formed by baking, microwaving, shallow frying and/or deep-fat frying.

The present invention further provides a method of forming a cooked food product, wherein the method of forming a cooked food product comprises the steps of:
a. forming a cooking composition, dough or batter according to the present invention; and
b. cooking the cooking composition, dough or batter.

The cooked food product may be a biscuit, muffin, donut, bread, pizza base, cookies, hardtack, pretzels, cut bread, wafers, sable, Langue du chat, macaroons, butter cakes (such as pound cake, fruit cake, Madeleine, Baumkuchen, castella), sponge cakes (such as short cake, roll cake, torte, decorated cake, chiffon cake), cream puffed confectionery, fermentation pastry, western style fresh confectionery such as pie and waffle, sweet buns, French bread, stollen, panettone, brioche, Danish pastry and croissants or crackers.

The time period necessary for cooking can be easily selected by a person of skill in the art and having regard to the consistency of the cooking composition, dough or batter, the thickness of the food product being prepared and/or the type of food product being formed.

It will also be appreciated that the food product may also be par-cooked, such that a fully cooked food product can be prepared at a later time. Once par-cooked, the food product may be stored, packaged and/or frozen.

Having regard to the disclosure above, the present invention also comprises the use of edible porous particles which encapsulate and retain a gas as a leavening agent in a cooking composition. Such use preferably comprises mixing the edible porous particle with inulin. In a further preferred embodiment, such use comprises mixing the edible porous particles are pre-blended with a fat or an oil, or emulsions thereof with water. In yet a further preferred embodiment, such use comprises mixing the edible porous particles with both inulin and a fat or an oil, or emulsions thereof with water.

The present invention further provides the use of an edible porous particle which encapsulates and retains a gas as a nucleating agent. Preferred blends include those described above, and include those for the use as a leavening agent.

The present invention further provides the use of an edible porous particle which encapsulates and retains a gas as a chemical leavening agent substitute in a cooking composition.

Finally, it will be appreciated that yet a further aspect of the present invention is the use of edible porous particles containing pressurized gas as a substitute for chemical leavening agents.

The present invention will now be described by way of example and with reference to the accompanying drawings in which:

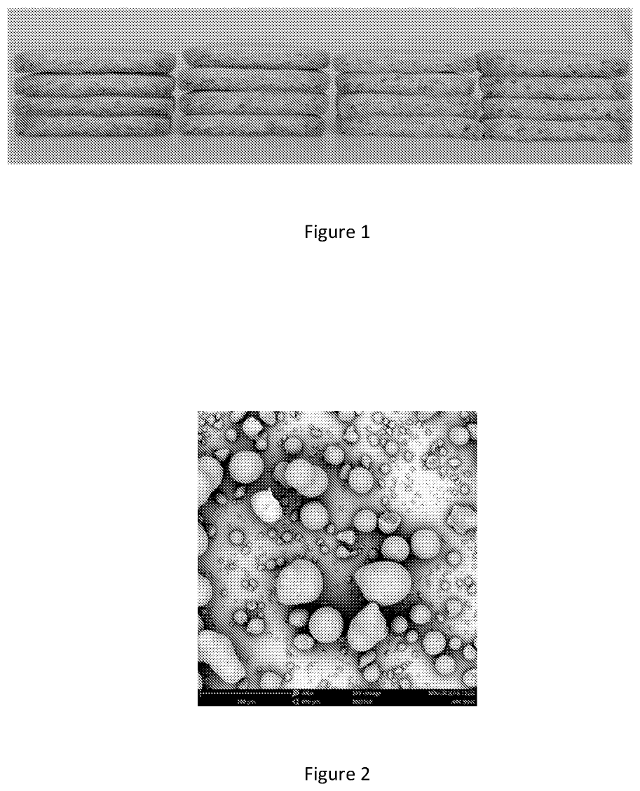

FIG. 1 is a photograph showing the cookies resulting from test 12, 13, 14 and 15 (from left to right);

FIG. 2 is a Scanning Electron Microscopy (SEM) of edible porous particles Vana Cappa B01;

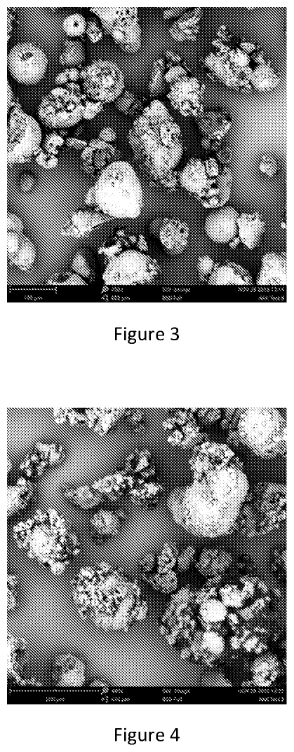

FIG. 3 is a Scanning Electron Microscopy (SEM) of Vana Cappa B01 coated with 15 wt % fully hydrogenated palm kernel oil; and

FIG. 4 is a Scanning Electron Microscopy (SEM) of Vana Cappa B01 coated with 29 wt % fully hydrogenated palm kernel oil.

### EXAMPLES

### Example 1

Example 1 illustrates the impact of traditional leavening agents on baking compositions. In this example hard sweet biscuits (type Marie, Petit Beurre) were made with and without baking powder.

The following ingredients were blended for 1 minute at first speed in a Diosna spiral kneader.

| Components (g) | Test 1 | Test 2 |
|---|---|---|
| Extruded shortening | 500 | 500 |
| Lecithin | 10 | 10 |
| Sugar | 900 | 900 |
| Invert sugar | 100 | 100 |
| Water (40° C.) | 750 | 750 |
| Salt | 30 | 30 |
| Sodium bicarbonate | 25 | 0 |
| Ammonium bicarbonate | 20 | 0 |

Then the following ingredients were added and blended for 2 minutes at speed 1.

| | | |
|---|---|---|
| Wheat flour | 3000 | 3000 |
| Skimmed milk powder | 60 | 60 |

Then the following ingredients were added and blended for 30 minutes at speed 2.

| | | |
|---|---|---|
| SAPP28 | 25 | 0 |
| Proteinase Stern BK5020 | 1 | 0 |

The dough subsequently formed was sheeted with a Fritsch lamination table to 20 mm thickness, turned 90° and rolled out to 1.3 mm (gap opening between the rolls). The sheeted dough was given a resting time of 5 minutes and was then pinned heavily. Circles of dough were cut with a diameter of 50 mm and baked for 7 minutes on a perforated baking plate at 240° C. (up)/170° C. (down) in a deck oven (Wachtel Stamm).

The results of the baked biscuits are shown in the following Table:

| | Test 1 | Test 2 |
|---|---|---|
| Average thickness of | 1.16 | 1.01 |
| baked biscuit/weight | | |
| of biscuit (mm/g) | | |
| Specific volume of | 2.16 | 1.78 |
| baked biscuit (ml/g) | | |

The specific volume of the baked biscuit was measured using the rapeseed displacement technique, which is well known in the art of bakery evaluation.

As shown from Example 1, both the thickness and the specific volume of the biscuit produced is increased due to the presence of a leavening agent.

### Example 2

In this example the effect of the gas-containing edible particles as chemical leavening agents are examined for the production of hard sweet biscuits (type Marie, Petit Beurre). These results are compared with hard sweet biscuits produced without the use of any leavening agent. The results can also be compared to Example 1.

The following ingredients were blended for 1 minute at first speed in a Diosna spiral kneader.

| Components (g) | Test 3 | Test 4 |
|---|---|---|
| Extruded shortening | 500 | 500 |
| Lecithin | 10 | 10 |
| Sugar S1 | 900 | 900 |
| Invert sugar | 100 | 100 |
| Water (40° C.) | 750 | 750 |
| Salt | 30 | 30 |

After which, the following ingredients were added and blended for 2 minutes at speed 1 and another 30 minutes at speed 2.

| | | |
|---|---|---|
| Wheat flour 11.5/680 | 3000 | 3000 |
| Skimmed milk powder | 60 | 60 |
| Vana Cappa B01¹ | 0 | 200 |

¹Foaming composition consisting of a maltodextrin matrix containing pressurised internal nitrogen gas (bulk density 350-550 g/l).

The dough subsequently formed was sheeted with a Fritsch lamination table to 20 mm thickness, turned 90° and rolled out to 1.3 mm (gap opening between the rolls).

The sheeted dough was given a resting time of 5 minutes and was then pinned heavily. Circles of dough were cut with a diameter of 50 mm and baked for 7 minutes on a perforated baking plate at 240° C. (up)/170° C. (down) in a deck oven (Wachtel Stamm).

The results of the baked biscuits are shown in the following Table:

| | Test 3 | Test 4 |
|---|---|---|
| Average thickness of baked | 1.03 | 1.19 |
| biscuit/weight of biscuit | | |
| (mm/g) | | |
| Specific volume of baked | 1.79 | 2.00 |
| biscuit (ml/g) | | |
| Sodium content (%) | 0.28 | 0.28 |

Test 4 clearly shows an increase in both the average thickness and the specific volume of the biscuits produced in comparison Test 3, which were formed without a leavening agent. The result of Test 4 is also very similar to the result of Test 1 (Example 1) wherein chemical leavening agents were used. In addition, the calculated sodium content in Test 1 (Example 1) is 0.55% whereas the calculated sodium content of Test 4 is only 0.28%. Thus, the absence of traditional chemical leavening agents in Test 4 results in a 49.1% reduction of the sodium content in the biscuit.

### Example 3

This example compares the effect of using gas-containing edible particles (Vana Cappa B01) as a leavening agent with traditional leavening agents, such as baking powder, when forming short dough biscuits. The biscuits were produced according to the recipe and procedure below.

| Components (g) | Test 5 | Test 6 | Test 7 |
|---|---|---|---|
| Flour 11.5/680 | 600 | 600 | 600 |
| Sugar S1 | 348 | 348 | 348 |
| Margarine¹ | 240 | 240 | 240 |
| Skimmed milk powder | 15 | 15 | 15 |
| Salt | 5 | 5 | 5 |
| Baking powder² | 0 | 12 | 0 |
| Vana Cappa B01³ | 0 | 0 | 40 |
| Water | 67 | 67 | 67 |

¹Margarine with 17.8% moisture.
²Baking powder composed of 45 wt % disodiumdiphosphate, 30 wt % sodium bicarbonate, 25 wt % modified starch.
³Foaming composition consisting of a maltodextrin matrix containing pressurised internal nitrogen gas (bulk density 350-550 g/l).

The margarine and sugar were mixed in a Hobart with flat beater for 1 minute at speed 1 followed by mixing for 1 minute at speed 2, with intermediate scraping down of the cream.

The margarine/sugar mix was further mixed for 1 minute at speed 1 while slowly adding the water. The cream was scraped down and further mixed for 30 seconds at speed 2.

The flour, along with the other dry components (skimmed milk powder, salt, baking powder, Vana Cappa B01) were added and the composition was further blended for 1 minute at speed 1.

The dough was immediately rolled out to 5 mm thickness with a Fritsch lamination table.

Circles of dough were cut with a diameter of 50 mm and baked for 18 minutes in a Wachtel Stamm deck oven at 180° C. (up)/160° C. (down).

The final properties of the biscuits produced are shown below.

| | Test 5 | Test 6 | Test 7 |
|---|---|---|---|
| Average diameter/baked | 4.90 | 5.20 | 5.01 |
| weight (mm/g) | | | |
| Average height/baked | 0.66 | 0.72 | 0.75 |
| weight (mm/g) | | | |
| Specific volume | 1.53 | 1.81 | 1.66 |
| (ml/g baked weight) | | | |
| Sodium content (%) | 0.37 | 0.59 | 0.36 |

Test 7 clearly demonstrates that the use of gas-containing edible particles comprising pressurized gas in accordance with the present invention (i.e. Vana Cappa) causes an increase in the specific volume, height and diameter of the biscuits formed, and thus contributes to the rising of the dough composition. Accordingly, the gas-containing edible particles comprising pressurized gas provide an alternative method of creating volume and porosity in short dough biscuits. The absence of traditional chemical leavening agents results in a 40.0% reduction of the sodium content in the biscuit without significant loss of baked volume.

### Example 4

In this example an optimum level of Vana Cappa B01 was determined in short dough cookies.

The cookies were produced according to the recipe and procedure below.

| Components (g) | Test 8 | Test 9 | Test 10 | Test 11 |
|---|---|---|---|---|
| Flour 11.5/680 | 600 | 600 | 600 | 600 |
| Sugar S1 | 348 | 348 | 348 | 348 |
| Extruded shortening¹ | 192 | 192 | 192 | 192 |
| Skimmed milk powder | 15 | 15 | 15 | 15 |
| Salt | 5 | 5 | 5 | 5 |
| Vana Cappa B01² | 0 | 10 | 20 | 30 |
| Water | 115 | 115 | 115 | 115 |

¹Palm based extruded shortening.
²Foaming composition consisting of a maltodextrin matrix containing pressurised internal nitrogen gas (bulk density 350-550 g/l).

The margarine and sugar were mixed in a Hobart with flat beater for 1 minute at speed 1 followed by mixing for 1.5 minutes at speed 2, with intermediate scraping down of the cream.

The fat/sugar mix was further mixed for 1 minute at speed 1 while slowly adding the water. The cream was scraped down and further mixed for 30 seconds at speed 2.

The flour, along with the other dry components (skimmed milk powder, salt, Vana Cappa B01) were added and the composition was further blended for 1 minute at speed 1.

The dough was immediately rolled out to 5 mm thickness with a Fritsch lamination table.

Circles of dough were cut with a diameter of 50 mm and baked for 18 minutes in a Wachtel Stamm deck oven at 180° C. (up)/160° C. (down).

The final properties of the biscuits produced are shown below.

| | Test 8 | Test 9 | Test 10 | Test 11 |
|---|---|---|---|---|
| Average diameter/ | 5.27 | 5.37 | 5.55 | 5.44 |
| baked weight (mm/g) | | | | |
| Average height/ | 0.67 | 0.71 | 0.77 | 0.76 |
| baked weight (mm/g) | | | | |
| Specific volume | 1.53 | 1.67 | 1.74 | 1.71 |
| (ml/g baked weight) | | | | |

The optimum level of Vana Cappa B01 was 20 g, or 1.54 wt % on dough weight.

### Example 5

A fat coating was applied on the Vana Cappa B01 samples by fluidized bed. Experiments were performed on the ProCepT fluid-bed 1 L set-up equipped with the bifluid melt nozzle. The fluid-bed was connected to the nitrogen unit in order to cool the fluid-bed to temperatures below 0° C. in order to solidify the melt.

Vana Cappa B01 was coated with PK39 (fully hydrogenated palm kernel oil) which have a melting point of ±40° C.

The biscuits were produced according to the recipe and procedure below.

| Components (g) | Test 12 | Test 13 | Test 14 | Test 15 |
|---|---|---|---|---|
| Flour 11.5/680 | 600 | 600 | 600 | 600 |
| Sugar S1 | 348 | 348 | 348 | 348 |
| Extruded shortening¹ | 192 | 192 | 192 | 192 |
| Skimmed milk powder | 15 | 15 | 15 | 15 |
| Salt | 5 | 5 | 5 | 5 |
| Vana Cappa B01 | 0 | 20 | 0 | 0 |
| Vana Cappa B01 coated | 0 | 0 | 23.5 | 0 |
| with 15.0% PK39² | | | | |
| Vana Cappa B01 coated | 0 | 0 | 0 | 28.1 |
| with 28.7% PK39² | | | | |
| Water | 115 | 115 | 115 | 115 |

¹Palm based extruded shortening.
²Weight percentage fat coating = weight of fat coating/(weight of fat coating + weight Vana Cappa).

| | Test 12 | Test 13 | Test 14 | Test 15 |
|---|---|---|---|---|
| Average diameter/ | 5.18 | 5.21 | 5.44 | 5.24 |
| baked weight (mm/g) | | | | |
| Average height/ | 0.68 | 0.74 | 0.76 | 0.76 |
| baked weight (mm/g) | | | | |
| Specific volume | 1.56 | 1.70 | 1.72 | 1.74 |
| (ml/g baked weight) | | | | |

A higher amount of fat coating has a positive effect on specific volume. Without wishing to be bound by theory, it is believed that the fat coating prevents a too early release of the pressurized gas during the dough phase.

Secondly the fat coating improves the effect on porosity of the biscuit structure (see FIG. 1).

### Example 6

Baking powders also heavily affect taste and colour due to its effect on pH and subsequently on Maillard reaction.

The purpose of this trial is to study if those changes can be compensated by certain amounts of sugars and proteins.

Fructose is known to improve the colour and taste of cookies in a positive way.

Whey protein isolates are very high in whey proteins (BiPro [Davisco] contains 93-95 g/100 g proteins; typically beta-lactoglobulin). Proteins are known to be important in Maillard reaction.

The cookies were produced according to the recipe and procedure below.

| Components (g) | Test 16 | Test 17 | Test 18 | Test 19 | Test 20 |
|---|---|---|---|---|---|
| Flour 11.5/680 | 600 | 600 | 600 | 600 | 600 |
| Sugar S1 | 348 | 348 | 248 | 348 | 248 |
| Extruded shortening¹ | 192 | 192 | 192 | 192 | 192 |
| Skimmed milk powder | 15 | 15 | 15 | 15 | 15 |
| Salt | 5 | 5 | 5 | 5 | 5 |
| Baking powder | 12 | 0 | 0 | 0 | 0 |
| Fructose | 0 | 0 | 100 | 0 | 100 |
| BiPro | 0 | 0 | 0 | 25 | 25 |
| Water | 115 | 115 | 115 | 115 | 115 |

¹Palm based extruded shortening.

The cookies were evaluated with a BYK colour guide.

| | Test 16 | Test 17 | Test 18 | Test 19 | Test 20 |
|---|---|---|---|---|---|
| L* | 71.2 | 76.96 | 63.90 | 70.18 | 54.63 |
| a* | 7.14 | 3.87 | 12.01 | 9.49 | 15.22 |
| b* | 27.95 | 25.18 | 30.10 | 32.07 | 29.09 |
| ΔE* | — | 7.2 | 9.0 | 4.8 | 18.5 |

L* = Lightness
a* = +red/−green
b* = +yellow/−blue
ΔE* = \sqrt{ (ΔL *)² + (Δa *)² + (Δb *)²} defines the total color difference between Test X (trial) and Test 16 (reference)

It is possible to regulate the colour of the cookies by fructose and BiPro, indicated by the lower L* value of test 18, 19 and 20 compared to Test 17.

Test 19 is closest to Test 16, indicated by the lowest ΔE* value.

### Example 7

This example shows the combined effect of Vana Cappa B01 (coated with 28.7% PK39) and milk proteins (BiPro—whey protein isolate) on leavening and colour.

The cookies were produced according to the recipe and procedure below.

| Components (g) | Test 21 | Test 22 |
|---|---|---|
| Flour 11.5/680 | 600 | 600 |
| Sugar S1 | 348 | 348 |
| Extruded shortening¹ | 192 | 192 |
| Skimmed milk powder | 15 | 15 |
| BiPro | 0 | 15 |
| Salt | 5 | 5 |
| Baking powder² | 12 | 0 |
| Vana Cappa B01 coated with 28.7% PK39³ | 0 | 28 |
| Water | 115 | 115 |

¹Palm based extruded shortening
²Baking powder composed of 45 wt % disodiumdiphosphate, 30 wt % sodium bicarbonate, 25 wt % modified starch
³Weight percentage fat coating = weight of fat coating/(weight of fat coating + weight Vana Cappa)

The cookies were evaluated and results are shown in below Table:

| | Test 21 | Test 22 |
|---|---|---|
| Average diameter/ | 5.6 | 5.3 |
| baked weight (mm/g) | | |
| Average height/ | 0.72 | 0.76 |
| baked weight (mm/g) | | |
| Specific volume | 1.80 | 1.77 |
| (ml/g baked weight) | | |
| L* | 73.33 | 74.45 |
| a* | 6.09 | 5.45 |
| b* | 27.80 | 27.33 |
| ΔE* | — | 1.38 |

L* = Lightness
a* = +red/−green
b* = +yellow/−blue
ΔE* = \sqrt{(ΔL *)² + (Δa *)² + (Δb *)²} defines the total color difference between Test 22 and Test 21 (reference)

A very similar result was obtained in terms of volume and colour creation in the cookies.

1-59. (canceled)

60. A cooking composition comprising a leavening agent, wherein the leavening agent is a chemical leavening agent substitute and consists essentially of edible porous particles which encapsulate and retain a gas.

61. The cooking composition of claim 60, wherein the edible porous particles are selected from E-number free carbohydrates, proteins, fats, and other E-number free ingredients or combinations thereof.

62. The cooking composition of claim 60, wherein the edible porous particles are substantially free of protein.

63. The cooking composition of claim 60, wherein at least 85 wt % of the edible porous particles is formed from one or more carbohydrate(s).

64. The cooking composition of claim 60, wherein the edible porous particles are selected from polyhydric alcohols, sugar alcohols, oligosaccharides, polysaccharides, starch, starch hydrolysis products, gums, soluble fibers, modified starches, modified celluloses, and mixtures thereof.

65. The cooking composition of claim 64, wherein the edible porous particles are selected from sugars, oligosaccharides, polysaccharides, starch, starch hydrolysis products, soluble fibers, and mixtures thereof.

66. The cooking composition of claim 64, wherein the edible porous starch is selected from one or more of corn, pea, potato, sweet potato, sorghum, banana, barley, wheat, rice, sago, amaranth, tapioca, arrowroot, and canna.

67. The cooking composition of claim 64, wherein the edible porous starch is tapioca maltodextrin.

68. The cooking composition of claim 64, wherein the starch hydrolysis products are selected from maltodextrins, glucose syrups, corn syrups, high-maltose syrups, and high-fructose syrups.

69. The cooking composition of claim 60, wherein the edible porous particle further comprises a gas maintained under pressure.

70. The cooking composition of claim 60, wherein the gas is selected from nitrogen, carbon dioxide, nitrous oxide, air, argon, oxygen, helium, hydrogen, or mixtures thereof.

71. The cooking composition of claim 70, wherein the gas is carbon dioxide.

72. The cooking composition of claim 60, wherein the edible porous particles are present in an amount of 0.1 to 10 wt %.

73. The cooking composition of claim 60, wherein the mean particle size of the edible porous particles is less than 250 μm.

74. The cooking composition of claim 60, wherein the bulk density of the edible porous particles is less than 1 g/cm³.

75. The cooking composition of claim 60, wherein the edible porous particles are in the form of a hollow shell, a closed-cell porous particle, or an open-cell porous particle.

76. The cooking composition of claim 75, wherein the closed-cell porous particles or open-cell porous particles have a mean pore size of less than 98 μm.

77. The cooking composition of claim 75, wherein the pores of the open-cell porous particles further comprise a restricted passage way.

78. The cooking composition of claim 77, wherein the restricted passage way has a diameter of less than 1 μm.

79. The cooking composition of claim 60, wherein the edible porous particle further comprises a surface coating layer.

80. The cooking composition of claim 79, wherein the surface coating layer is selected from one or more of xanthan, alginates, carrageenans, guar, gellan, locust bean, hydrolysed gums, fats, and oils.

81. The cooking composition of claim 80, wherein the surface coating layer is a fat or an oil.

82. The cooking composition of claim 81, wherein the fat or oil is selected from one or more of lard, tallow, lauric fats, and interesterified and/or hydrogenated fats or oils.

83. The cooking composition of claim 60, wherein the composition further comprises an additive to delay starch gelatinization.

84. The cooking composition of claim 83, wherein the additive to delay starch gelatinization is selected from inulin, sugar, salt, a high molecular weight carbohydrate, an edible acid, and/or a monoglyceride.

85. The cooking composition of claim 83, wherein the additive to delay starch gelatinization is inulin.

86. The cooking composition of claim 83, wherein the additive to delay starch gelatinization is present in an amount of from 0.1 to 10 wt %.

87. The cooking composition of claim 60, wherein the composition does not comprise a biological leavening agent.

88. The cooking composition of claim 60, wherein the leavening agent is selected from either yeast or sourdough.

89. The cooking composition of claim 60, wherein the composition further comprises one or more of flour, milk powder, sugar, sugar substitutes, protein, emulsifiers, starch, salt, spices, flavor components, powdered colorants, cocoa, thickening and gelling agents, egg powder, enzymes, gluten, preservatives, sweeteners, oxidizing agents, reducing agents, anti-oxidants, and acidity regulators.

90. The cooking composition of claim 89, wherein at least part of the sugar is substituted with inulin.

91. The cooking composition of claim 90, wherein the inulin replaces up to 50 wt % of the sugar present in a baking composition without inulin.

92. The cooking composition of claim 60, wherein the composition further comprises one or more of eggs, water, liquid emulsifier, liquid sugar and syrups, milk, liquid flavors, liquid colorants, alcohols, humectants, honey, liquid preservatives, liquid sweeteners, liquid oxidizing agents, liquid reducing agents, liquid anti-oxidants, liquid acidity regulators, and liquid enzymes.

93. The cooking composition of claim 60, wherein the composition further comprises a fat or an oil, or emulsions thereof with water.

94. The cooking composition of claim 93, wherein the composition further comprises margarine or butter.

95. The cooking composition of claim 93, wherein the fat is vegetable-derived, animal-derived, or blends thereof.

96. A dough formed from the cooking composition of claim 60.

97. The dough of claim 96, wherein the dough comprises:
20 to 70% flour;
1 to 50% water;
0 to 50% sugar;
0 to 5% salt;
0.5 to 5% leavening agent; and
0 to 40% fat.

98. The dough of claim 96, wherein the leavening agent comprises a biological leavening agent.

99. A batter formed from the cooking composition of claim 60.

100. A process of forming a dough or batter comprising the steps of:
(a) mixing wet components;
(b) mixing dry components, including a leavening agent consisting essentially of edible porous particles which encapsulate and retain a gas; and
(c) blending the wet components of step (a) and the dry components of step (b) until a dough or batter is formed.

101. A process of forming a dough or batter comprising the steps of:
(a) mixing wet components, including a leavening agent consisting essentially of edible porous particles which encapsulate and retain a gas;
(b) mixing dry components; and
(c) blending the wet components of step (a) and the dry components of step (b) until a dough or batter is formed.

102. The process of claim 101, wherein the mixing of wet components comprises mixing a fat component with the leavening agent.

103. The process of claim 102, further comprising adding inulin.

104. A cooked food product formed from the dough of claim 96.

105. A process of forming a cooked food product, comprising the steps of:
(a) forming a dough or batter, wherein the dough or batter comprises the cooking composition of claim 60; and
(b) cooking the dough or batter.

106. The process of claim 105, wherein the cooking includes baking, frying, and/or microwaving.

107. The process of claim 105, wherein the cooking includes full and par-cooking.

108. A cooked food product produced by the process of claim 105.

109. The cooked food product of claim 108, wherein the product is a biscuit, muffin, donut, bread, pizza base, cookie, hardtack, pretzel, cut bread, wafer, sable, Langue du chat, macaroon, butter cake, sponge cake, cream puffed confectionery, fermentation pastry, western style fresh confectionery, sweet buns, French bread, stollen, panettone, brioche, Danish pastry, croissants, or crackers.

110. A precursor composition for forming the cooking composition of claim 60, wherein the precursor composition comprises a mixture of edible porous particles which encapsulate and retain a gas and inulin.

111. The precursor composition of claim 110, further comprising a fat.

112. An edible porous particle which encapsulates and retains a gas as a leavening agent in a cooking composition.

113. A composition consisting of an edible porous particle which encapsulates and retains a gas and inulin as a leavening agent in a cooking composition.

114. The edible porous particle of claim 112, wherein the leavening agent is pre-blended with a fat composition.

115. An edible porous particle which encapsulates and retains a gas as a chemical leavening agent substitute in a cooking composition.
